(19) United States
(12) Patent Application Publication
(10) Pub. No.: US 2012/0310541 A1
(43) Pub. Date: Dec. 6, 2012

(54) ONLINE DETERMINATION OF INTER ALIA FAT, PROTEIN, LACTOSE, SOMATIC CELL COUNT AND UREA IN MILK BY DIELECTRIC SPECTROSCOPY BETWEEN 0.3 MHZ AND 1.4 GHZ USING CHEMOMETRIC EVALUATION

(76) Inventors: Gil Katz, boar-Na Emek HaYarden (IL); Martin I. Kutscher, Doar-Na Galil Elyon (IL); Benjamin Sabbah, Haifa (IL)

(21) Appl. No.: 13/511,886

(22) PCT Filed: Nov. 22, 2010
(86) PCT No.: PCT/IL2010/000977

§ 371 Date: May 24, 2012

Related U.S. Application Data
(60) Provisional application No. 61/264,280, filed on Nov. 25, 2009.

(51) Int. Cl. G01N 27/02; G01N 25/00; G06F 19/00

(52) U.S. Cl. 702/19

(57) ABSTRACT

A method for determining a concentration of at least one component of milk includes measuring impedance values between two electrodes associated with a cell containing a milk sample at each of at least three frequencies, and estimating a concentration of the at least one component from a polynomial expression in which the impedance values at the at least three frequencies are variables. A system for determining a concentration of at least one component of milk includes a sampling cell including a milk sample, electrodes operative to electrify the milk sample with excitation signals at a plurality of frequencies including at least three frequencies, a signal generator for generating the excitation signals, circuitry for determining a relationship between an amplitude and phase of reflected and incident signals obtained from the signal generator, and a processor that receives the relative amplitude and phase and estimates a concentration of at least one component of milk based on a polynomial expression relating measured impedance values at a plurality of frequencies to concentrations of at least one component of milk.

### FIELD OF THE INVENTION

The present invention, in some embodiments thereof, relates to quantitative determination of milk components using techniques of dielectric spectroscopy and more particularly, but not exclusively to non-destructive on-site determination of milk components using techniques of dielectric spectroscopy.

### BACKGROUND OF THE INVENTION

Dielectric Spectroscopy (also known as Electrochemical Impedance Spectroscopy (EIS)) is a measurement technique to determine physical properties of materials by analyzing their response to an alternating current applied over a range of frequencies. Typically, impedance of the material is determined as a function of a frequency of Alternating Current (AC) and is used to characterize the material. The impedance can be separated into frequency dependent conductivity and relative permittivity of the material.

In some known research studies, dielectric spectroscopy techniques have been used to determining physical properties of colloids. Colloids are a two-phase mixture of particles suspended in a medium. Each particle in the mixture has an electric layer surrounding it that affects the aggregation and/or dissociation of the particles in the mixture. Different aggregations of particles respond differently to different frequencies. Milk is an example of an emulsified colloid that is a mixture of fat globules and solid particles suspended in a liquid solution.

In the article, “Electric Impedance Spectroscopy for Yogurt Processing,” by Kitamura et al., published in Food Science Technology Research Vol. 6 No. 4, pg. 310-313 (2000), the contents of which is incorporated herein by reference, there is described a non-destructive EIS technique for monitoring yogurt processing. Four electrodes composed of two platinum plates (20×20 mm) were fixed with a 10 mm interval in a 50 ml glass container of yogurt. The impedance was measured every 10 minutes in the range between 0.05 to 100 KHz at 0.2 AC-V during the yogurt processing. Impedances (Z) ratio (Z obtained at 100 KHz divided by Z obtained at 0.1 KHz) were calculated and monitored over time to determine hardness, pH and acidity of yogurt during yogurt processing. Time course curves determined for both pH and acidity had only gentle slopes showing the progress of lactic fermentation; however the time course for hardness had bending points indicating the start of coagulation.

In an article “Dielectric study of milk for frequencies between 1 and 20 GHz” by Nunes et al., published by Journal of Food Engineering Vol. 76, Pgs. 250-255 (2006), the contents of which is incorporated herein by reference, there is described a study to determine the complex permittivity of milk over the frequency range of 1-20 GHz. UHT whole, low fat and skim milk were examined, fresh from the container, and over a period of two weeks while they were allowed to spoil at room temperature. Samples were allowed to reach equilibrium before being tested (approximately 50 min). The Debye relation, with an additional term for ionic conduction losses was fitted to the data, and six parameters were extracted. The authors found that the variation of these parameters with fat content and dilution suggest that they may be useful to roughly determine the milk's content in terms of groups of materials (ionic compounds, fats, and carbohydrates and proteins). It is noted in the article that the instrumentation used in the study is highly sophisticated, expensive, required skilled personnel to operate and maintain, and was not something many businesses would consider buying or using as part of their processing protocols. It is suggested that a much simpler instrument, operating at a few select frequencies might be cheaper to build, would not require an operator with an advanced degree, and may permit rapid, on-line, monitoring of product quality

U.S. Pat. No. 4,325,028 entitled “Examination Apparatus for Milk drawing from quarter Mammae of a Milk Cow” the contents of which is incorporated herein by reference, describes an apparatus for detecting deterioration of milk due to mastitis or milk fever, on-line. The method described is based on determining conductivity of milk. In every flow passage of milk sucked out from each quarter mamma, a trap is positioned. In each trap, a certain quantity of milk is drawn from each quarter mamma and is exchanged successively with milk newly sucked out. The electric conductivity of the milk is measured by means of electrodes positioned in each of the traps. The conductivity from each quarter mamma is compared and a warning is provided in response to determining a predefined difference in conductivity.

### SUMMARY OF THE INVENTION

According to an aspect of some embodiments of the present invention there is provided a system and method for non-destructive on-site determination of milk components based on measured dielectric properties of milk over a plurality of frequencies.

According to an aspect of some embodiments of the present invention there is provided a method for determining a concentration of at least one component of milk, the method comprising: measuring the impedance between two electrodes associated with a cell containing a milk sample at each of at least three frequencies; estimating a concentration of the at least one component from a polynomial expression in which the impedance values are variables.

Optionally, the coefficients of the polynomial expression are defined based on analysis of impedance values and concentrations values of the at least one component obtained from a plurality of samples of the milk, wherein the concentrations values are determined by another means.

Optionally, the polynomial expression for defining the at least one component is defined as a function of impedance measured at between 8 to 10 pre-selected frequencies.

Optionally, the method comprises selecting the at least three frequencies for estimating concentrations of each milk component.

Optionally, the selecting is based on an iterative partial least square regression.

Optionally, the at least three frequencies range between 0.3 MHz and 1.4 GHz.

Optionally, the at least three frequencies are a frequency sweep of discrete frequencies over a defined band.

Optionally, the estimating is performed using chemometric analysis.

Optionally, the estimating is performed on a milk sample contained in a flow through sampling cell, wherein the sampling cell repeatedly and automatically receives milk samples from a milk conduit as milk flows through conduit.

Optionally, the estimating is performed on-line in a milking parlor.

Optionally, the milk sample is stationary in the sampling cell.

Optionally, temperature is a variable of the polynomial expression.

Optionally, the polynomial expression is defined based on partial least square regression method.

Optionally, the polynomial expression is a first order expression.

According to an aspect of some embodiments of the present invention there is provided a system for determining a concentration of at least one component of milk, the method comprising: a sampling cell including a milk sample; electrodes operative to electrify the milk sample with excitation signals at a plurality of frequencies including at least three frequencies; a signal generator for generating the excitation signals; circuitry for determining a relationship between an amplitude and phase of reflected and incident signals obtained from the signal generator; and a processor that receives the relative amplitude and phase and estimates a concentration of at least one component of milk based on a polynomial expression relating measured impedance values at a plurality of frequencies to concentrations of at least one component of milk.

Optionally, the signal generator generates signals at frequencies ranging between 0.3 MHz and 1.4 GHz.

Optionally, the system comprises a memory having stored therein pre-defined empirical coefficients of the polynomial expression along with the concentrations of samples with which they are associated as a reference database for use in measurements of unknown samples.

Optionally, the sampling cell is a flow through sampling cell that repeatedly and automatically receives milk samples from a milk conduit as milk flows through conduit.

Optionally, the sampling cell is a recessed cavity adjoining a main flow conduit of milk in a milk-parlor.

Optionally, the circuitry includes a directional coupler that receives a signal reflected from the milk sample in response to excitation of the milk sample.

Optionally, the system comprises a controller operative to store the amplitude and phase values in response to detecting a steady input from the circuitry.

Optionally, the controller is further operative to synchronize electrifying of the milk sample with reception of the milk sample.

Optionally, the electrodes are coated with lipophobic material.

Optionally, the electrodes are concentric.

Optionally, the electrodes include a ring shaped electrode surrounding an inner electrode.

Optionally, the ring shaped electrode includes one or more openings through which a milk sample can flow.

Optionally, the electrodes are arc shaped electrodes.

Optionally, the electrodes are positioned with respect to each other so that their circle-centers coincide.

Optionally, the electrodes are physically isolated from the milk sample.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified schematic block diagram of a static analysis system in accordance with some embodiments of the present invention;

FIG. 1B is a simplified schematic block diagram of a flow through analysis system in accordance with some embodiments of the present invention;

FIGS. 2A, 2B and 2C show a simplified schematic isometric view, top view, and cross sectional view of a sampling cell and arc shaped electrodes in accordance with some embodiments of the present invention;

FIGS. 3A, 3B and 3C show a simplified schematic isometric view, top view, and cross sectional view of a sampling cell and concentric electrodes in accordance with some embodiments of the present invention;

FIGS. 4A, 4B and 4C show a simplified schematic isometric view, top view, and externally positioned electrodes in accordance with some embodiments of the present invention;

FIGS. 5A, 5B and 5C show a simplified schematic isometric view, top view, and cross sectional view of a sampling cell and externally positioned arc shaped electrodes in accordance with some embodiments of the present invention;

FIG. 6 is a simplified flow chart describing an exemplary method for determining impedance of milk in a sampling cell based on received incident and reflected signals in accordance with some embodiments of the present invention;

FIG. 7 is a simplified flow chart of an exemplary method for defining a polynomial expression for expressing concentrations of a pre-defined milk component as a function of impedance at a plurality of excitation frequencies in accordance with some embodiments of the present invention;

FIG. 8 is an exemplary plot of real and imaginary RF spectrum of a milk sample over seven different temperatures in accordance with some embodiments of the present invention;

FIG. 9 is an exemplary Nyquist diagram of showing a frequency response of bacterial contaminated milk as compared to a frequency response of healthy milk in accordance with some embodiments of the present invention;

FIG. 10 is a plot of experimentally found regression vector coefficients for milk lactose determination when using a particular experimental structure in accordance with some embodiments of the present invention;

FIG. 11A is a plot showing an exemplary correlation between measured and estimated values of fat based on experimental results with a particular structure in accordance with some embodiments of the present invention;

FIG. 11B is an exemplary plot showing exemplary measured and estimated values of fat in accordance with some embodiments of the present invention;

FIG. 12A is an exemplary plot showing an exemplary correlation between measured and estimated values of protein in accordance with some embodiments of the present invention;

FIG. 12B is an exemplary plot showing exemplary measured and estimated values of protein in accordance with some embodiments of the present invention;

FIG. 13A is an exemplary plot showing an exemplary correlation between measured and estimated values of lactose in accordance with some embodiments of the present invention;

FIG. 13B is an exemplary plot showing exemplary measured and estimated values of lactose in accordance with some embodiments of the present invention;

FIG. 14 is an exemplary plot showing an exemplary correlation between exemplary measured results and estimated values for log of SCC in accordance with some embodiments of the present invention;

FIG. 15A is an exemplary plot showing an exemplary correlation between measured and estimated values of urea in accordance with some embodiments of the present invention; and

FIG. 15B is an exemplary plot showing exemplary measured and estimated values of urea in accordance with some embodiments of the present invention;

### DESCRIPTION OF SPECIFIC EMBODIMENTS OF THE INVENTION

The present invention, in some embodiments thereof, relates to quantitative determination of milk components using techniques of dielectric spectroscopy and more particularly, but not exclusively to non-destructive on-site determination of milk components using techniques of dielectric spectroscopy.

An aspect of some embodiments of the present invention provides for a method to determine impedance of milk samples in a sampling cell over a plurality of frequencies within a radio frequency band and based on determined impedance estimate concentrations of one or more milk components. According to some embodiments of the present invention, impedance of milk samples in a sampling cell is determined over a plurality of frequencies ranging between the 0.3 MHz and 1.4 GHz or 0.3 MHz to 1 GHz. The present inventors have found that impedances of milk in a sampling cell determined at frequencies ranging between 100 MHz to 2 GHz are sensitive to milk components and can be used to predict concentrations of one or more milk components including fat protein, lactose, Somatic Cell Count (SCC) and urea. Optionally, frequencies ranging between 300 MHz and 1.4 GHz are used.

An advantage of determining concentrations of milk components based on dielectric spectroscopy, e.g. using RF frequencies ranging between 0.3 and 1.4 GHz as compared to optical spectroscopy methods is that the relatively short wavelengths are sensitive to penetration through water and therefore water can be used to calibrate the system.

According to some embodiments of the present invention, 8-12 frequencies in the range of frequencies are selected to estimate concentrations of each of the pre-defined milk components based on a defined polynomial expression. According to some embodiments of the present invention, the polynomial expression is a first order expression. Optionally, second order and/or higher expressions may be included to provide higher precision at a cost of more computing power.

According to some embodiments of the present invention, the impedance measurements and estimations of milk components are performed on-site in a milking parlor in a static sampling cell and/or in a flow through sampling cell. According to some embodiments of the present invention, the impedance measurements are performed in real time on a flow through sampling cell adjoining the main flow conduit of the milk in the milking parlor. Typically, the sampling cell fills with a constantly changing sample of flowing milk in between periods of measurement.

According to some embodiments of the present invention, a concentration of each component is estimated from a polynomial expression defined for that component. The polynomial expression is a function of determined impedance values, e.g. real and imaginary components of impedance, at pre-selected frequencies.

According to some embodiments of the present invention, the coefficients of the polynomial expression are empirical coefficients that are pre-defined based on statistical analysis of impedance values obtained from a plurality of samples of the fluid having known concentrations of the component. Statistical analysis may include for example partial least square regression method or a ridge least square regression method.

In some exemplary embodiments, the polynomial expression is also a function of temperature of the milk sample and a pre-defined empirical temperature coefficient is similarly based on statistical analysis. Optionally, temperature is regulated and the milk sample is maintained at a constant temperature. Typically, once determined, the empirical coefficients are stored in memory and used to estimate concentrations of components of milk. Optionally, the determined coefficients are stored along with the concentrations of samples with which they are associated as a reference database for use in measurements of unknown samples.

An aspect of some embodiments of the present invention provides for a system operative to determine impedances of milk samples over a plurality of frequencies within a RF band and, based on the determined impedances estimate concentrations of one or more milk components. According to some embodiments of the present invention, the system includes two separated cylindrical electrodes positioned in the sampling cell containing a milk sample. Optionally, the electrodes have a diameter of between 2.1-2.8 mm, e.g. 2.5 mm and are positioned at a 3.5-7 mm, e.g. 5 mm apart (center to center). Optionally, the electrodes are coated with lipophobic material to avoid fat accumulating on the electrodes that may effect the measurements. In some exemplary embodiments, the electrodes are positioned outside of the sampling cell at a distance of less than 1.5 or 2 mm from the milk sample. Optionally, in such a case capacitance measurements are taken to determine effects of isolated electrodes on the impedance measurements. Optionally, a distance between the electrodes is selected to be in a same range as wavelengths used to excite the milk sample in the sampling cell.

According to some embodiments of the present invention, a frequency generator generates an RF signal over a range of pre-defined frequencies at a pre-defined rate of change of frequency. According to some embodiments of the present invention, a directional coupler applies the RF output from the amplifier to the electrodes while providing a sample of the original incident RF signal at an incident output and a sample of the signal reflected from the sampling cell at a reflection output. Typically, the output impedance of the system, e.g. including the signal generator, transmission cables over which the output is transmitted, and the electrodes are selected to be matched, e.g. with an impedance of about 50 Ohms and the signal reflected is attributed to the unmatched impedance of the milk sample.

According to some embodiments of the present invention, a processing unit and/or dedicated circuitry is operative to receive the incident and reflected signal and measure phase differences and amplitude ratios between the incident and reflected signals. According to some embodiments of the present invention, a same or other processing unit and/or dedicated circuitry determines an impedance value of the milk sample from the input received for each of the frequencies.

Optionally, the system includes a temperature sensor operative to sense a temperature of the milk sample, and the processing unit is additionally operative to receive temperature measurements obtained from a temperature sensor. Optionally, the system includes a temperature regulator to regulate the temperature of the sampling cell.

According to some embodiments of the present invention, a processing unit is operable to estimate concentrations of milk components based on determined impedance values and a pre-defined polynomial expression. Optionally, predication is additionally based on temperature readings from the temperature sensor.

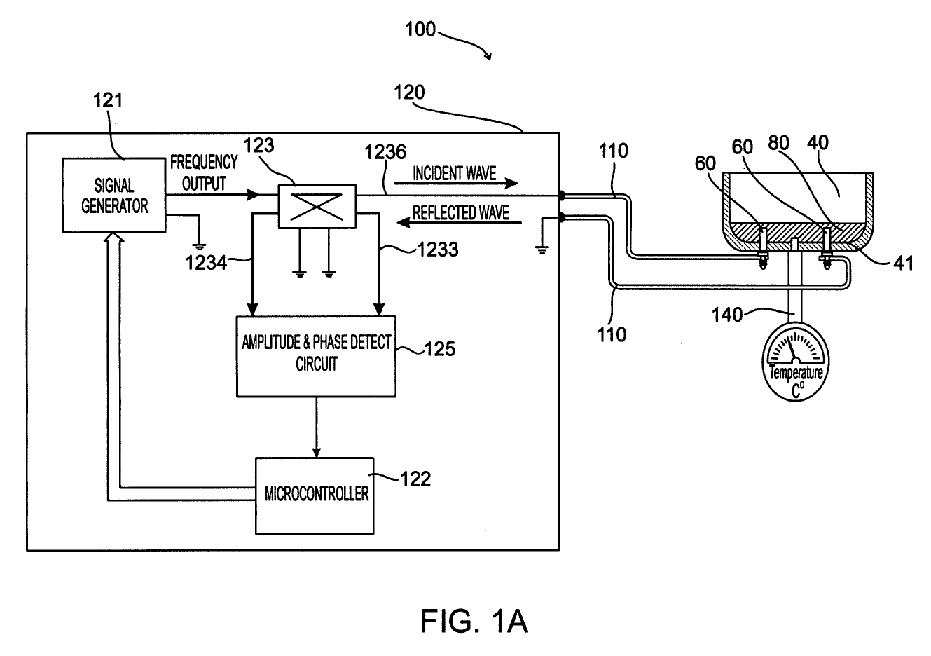

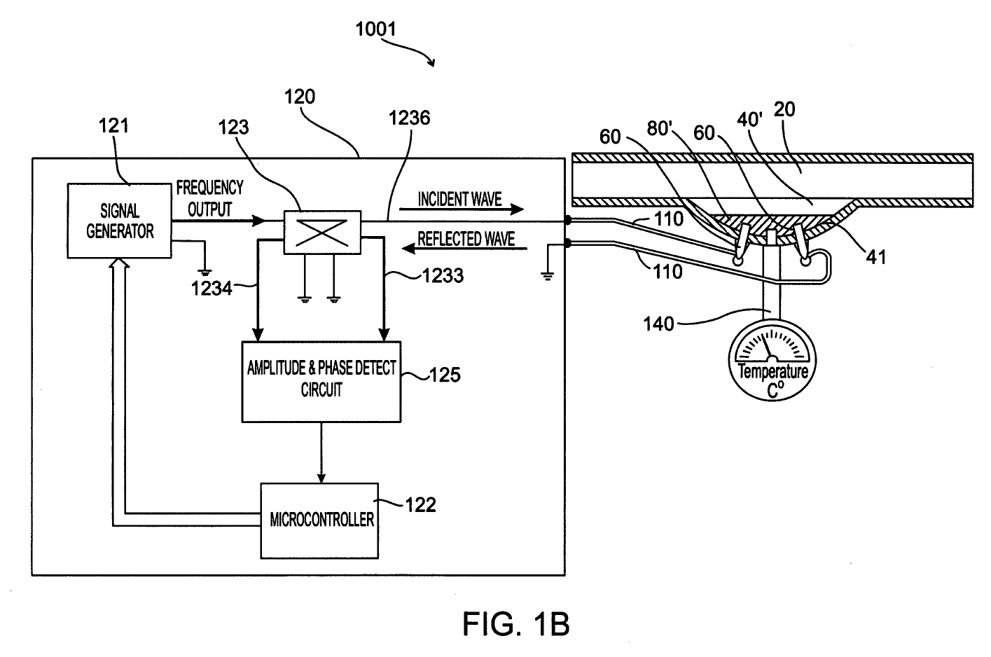

Reference is now made to FIG. 1A showing a simplified schematic block diagram of a static analysis system in accordance with some embodiments of the present invention. Accordance with some embodiments of the present invention, an analysis system 100 analyzes a milk sample 80 contained in a sampling cell 40 to determine impedance values of milk at a range of frequencies. At least two electrodes 60 immersed in the milk sample 80 excite the milk sample at a plurality of different frequencies. According to some embodiments of the present invention, a signal generator 121 generates an excitation signal over a range of pre-defined discrete frequencies and a directional coupler 123 detects an incident output 1233 and a reflection output 1234 for each excitation signal generated by generator 121. Amplitude and phase detect circuit 125 then measures an amplitude ratio and phase difference between the sampled incident and reflected waves and passes these values to microcontroller 122 which computes the impedance of the milk.

According to some embodiments of the present invention, analysis system 100 is an on-site analysis system operative to estimate concentration of pre-defined components of milk on-site and in real time based on computed impedance values of the milk over an RF band. According to some embodiments of the present invention, the pre-defined components of milk include fat, protein, lactose, SCC and urea. According to some embodiments of the present invention, analysis of milk components, e.g. estimation of concentrations of pre-defined milk components is performed automatically by analysis system 100 and human intervention is not required. In some exemplary embodiments, an operator initiates analysis after applying a milk sample, e.g. milk sample 80 into static sampling cell 40 and the analysis is performed automatically. Typically, sampling cell 40 is constructed from a non-conductive material, e.g. a non-conductive polymer.

Excitation signals are generated by signal generator 121 and transmitted over a matching impedance cable 110. Typically, the excitation signal is a sine wave in a RF spectrum. Optionally, the signal generator has a power output of about 0-3 dBmW, e.g. 0 dBmW or 2 dBmW providing an acceptable signal to noise ratio in the receiver while not strong enough to overload the receiver. In some exemplary embodiments, the frequencies of the excitation signal range between 300 KHz to 1.4 GHz. Typically, signal generator 121 includes and/or is associated with an amplifier to amplify the excitation signal to a level that can excite milk sample 80, e.g. 0 dBmW or 2 dBmW. Typically, the output impedance of the amplifier and signal generator match impedance values of cables 110 and electrodes 60, e.g. 50 Ohms. Although shown as two lines, cable 110 typically has a coaxial structure with a grounded outer conductor which is especially advantageous at higher frequencies.

According to some embodiments of the present invention, electrodes 60 are introduced into sampling cell 40 through a floor 41 of sampling cell 40 and protrude into a volume of the milk sample at least 2-4, e.g. 3 mm from floor 41. According to some embodiments of the present invention, electrodes 60 are 3-7 mm, e.g. 5 mm apart (center to center).

Typically, electrodes 60 are immersed in milk sample 80 and are formed from and/or coated with non-corroding material. Optionally, the electrodes are formed from stainless steel, e.g. cold drawn stainless steel, type 316L. Optionally, the electrodes are formed from Platinum (Pt), and/or coated with Titanium (Ti) or Nickel Titanium (NiTi) coated electrodes. According to some embodiments of the present invention, the electrodes are cylindrical in shape with a diameter of 1.7-4 mm, e.g. 2.5 mm. Optionally, the electrodes are formed from two concentric electrodes, e.g. ring electrodes to enhance the excitation signal through milk sample 80. According to some embodiments of the present invention, the electrodes are coated with lipophobic material, e.g. Nanotol® as described at (www.cenano.de/nanotechnology-products/products-choice/nanotol-r-the-universal-sealant/), downloaded on Nov. 10, 2009 the contents of which is incorporated herein by reference. The present inventors have found that milk fat tends to accumulate on electrodes and that the accumulation of fat over time effects accuracy of the impedance measurements. Optionally, a lipophobic coating may be applied avoid milk fat accumulating on the electrodes.

Optionally, the electrodes are isolated from milk sample 80 and positioned outside the sampling chamber but proximal to milk sample 80, e.g. within 1 mm from the milk sample.

According to some embodiments of the present invention, a temperature sensor 140 monitors a temperature of milk sample 80. In some exemplary embodiments, sensed temperature is used to regulate a temperature of milk sample 80 to a constant pre-defined temperature. Optionally, temperature measurements are received by microcontroller 122 and any fluctuations in temperatures are accounted for when determining impedance values of milk sample 80.

Optionally, the microprocessor has stored values for the amplitude and phase characteristics of directional coupler 123 (although for a completely symmetrical directional coupler, these values can be neglected) and the length of cable 110 to correct the phase as a function of frequency.

According to some embodiments of the present invention, microcontroller 122 controls the analysis process and signal generator 121. In some exemplary embodiments, micro-controller 122 initiates an analysis scan by stepping the signal generator, one frequency at a time, from the start frequency, e.g. 300 KHz to the end frequency, e.g. of 1.3 GHz at predetermined frequency steps. At each frequency step, microcontroller 122 waits for a steady signal and then samples the amplitudes and phases of the incident and reflected signals. Optionally, microcontroller 122 additionally determines the impedance of a sampling cell containing milk samples at each point in the frequency scan based on received phase and amplitude values for the reflected and incident signals. Alternatively, impedance of a sampling cell containing a milk sample is determined by a processing unit associated with micro-controller 122 and/or by dedicated circuitry.

According to some embodiments of the present invention, microcontroller 122 is additionally operative to estimate concentrations of one or more pre-defined milk components based on determined impedance values by methods described in detail herein. Alternatively, an alternate processing unit is applied to receive impedance values from micro-controller 122 and/or dedicated circuitry and determine concentrations of pre-defined milk components therefrom.

Reference is now made to FIG. 1B showing a simplified schematic block diagram of a flow through analysis system in accordance with some embodiments of the present invention. According to some embodiments, analysis system 100′ includes a flow through sampling cell 40′ that repeatedly and automatically receives milk samples 80′ from a milk conduit 20 as milk flows through conduit 20. In some exemplary embodiments, sampling cell 40′ is a recessed cavity adjoining a main flow conduit of milk in a milk-parlor and is located in a generally downward direction with respect to conduit 20 such that it fills with a changing milk sample as milk flows through conduit 20. Typically, sampling cell 40′ is constructed from a non-conductive material, e.g. a non-conductive polymer. In some exemplary embodiments, pulsation of a vacuum system fluidly connected to milk conduit 20 replaces each milk sample 80 with a next milk sample in sampling cell 40. The recess geometry of sampling cell 40′ provides for containing milk sample 80′ for a pre-determined time period, e.g. between 1-4 seconds and/or 2 seconds without pulsation and turbulent flow so that impedance measurements may be made while the milk is in a static and/or a relaxed state. In some exemplary embodiments, the sampling cell contains between 3.5-15 cc of milk, e.g. 3.5 cc in a flow through sampling cell and 5-10 cc in a static sampling cell.

According to some embodiments, an in-line sampling cell described in International Patent Publication No. WO 03/040704, which is incorporated herein by reference, can be similarly applied to in-line sampling cell 40′.

According to some embodiments of the present invention, microcontroller 122′ operates similar to the operation of microcontroller 122 as described in reference to FIG. 1A but is further operative to synchronize of milk sample 80′ analysis with in-flow of milk sample 80′ in sampling cell 40′. Other components of analysis system 100′ are similar to those described in reference to FIG. 1A and operate in a similar manner.

In some exemplary embodiments, calibration is performed when disconnecting coaxial cable 110 and connecting an open, a short and then a 50 Ohm termination to ends of coaxial cables 110. The impedance measured at electrodes 60 are then calibrated relative to 50 Ohms.

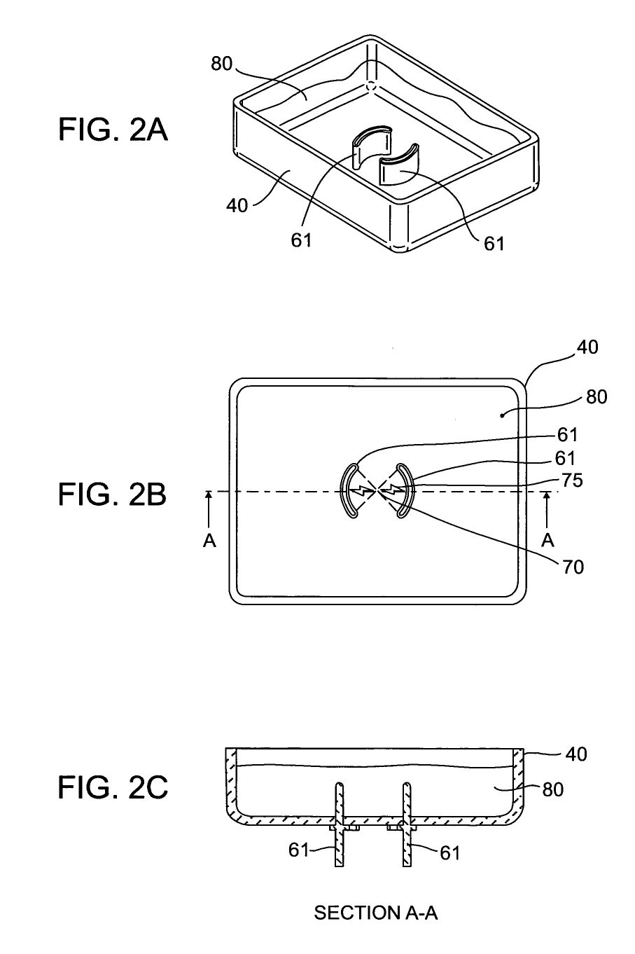

Reference is now made to FIGS. 2A, 2B and 2C showing an isometric, top, and cross sectional view of a sampling cell and arc shaped electrodes in accordance with some embodiments of the present invention. According to some embodiments of the present invention, electrodes 61 are circular arcs. Typically, the distance, e.g. a distance along a diameter between electrodes 61 and through center 70 is chosen to match a wavelength(s) of the transmitted signal, e.g. 5 mm distance for 1 GHz signal. Optionally, electrodes 61 are similar, e.g. the same in curvature and dimension.

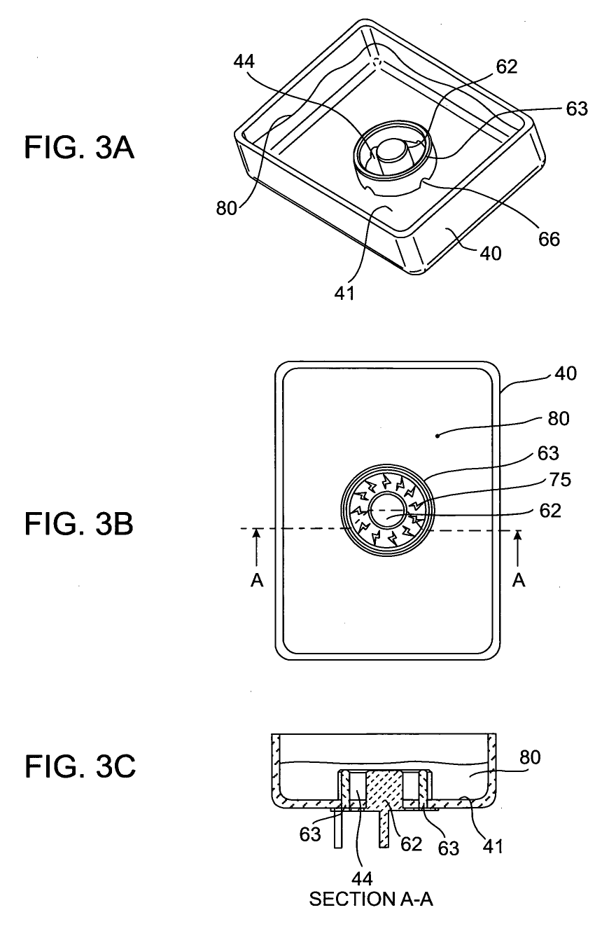

Reference is now made to FIGS. 3A, 3B and 3C showing an isometric, top, and cross sectional view of a sampling cell and concentric electrodes in accordance with some embodiments of the present invention. According to some embodiments of the present invention, electrodes 62 and 63 in sampling cell 40 are arranged as concentric rings with milk occupying a space 44 between electrodes 62 and 63. Optionally electrode 62 is a solid rod electrode and is surrounded by ring shaped electrode 63. Optionally, surrounding electrode 63 includes one or more openings 66 that allow milk to flow into and out of space 44. Typically, openings 66 are formed near a level of floor 41 of sampling cell 40 so that a milk sample can freely enter into space 44 as it is introduced into sampling chamber 40.

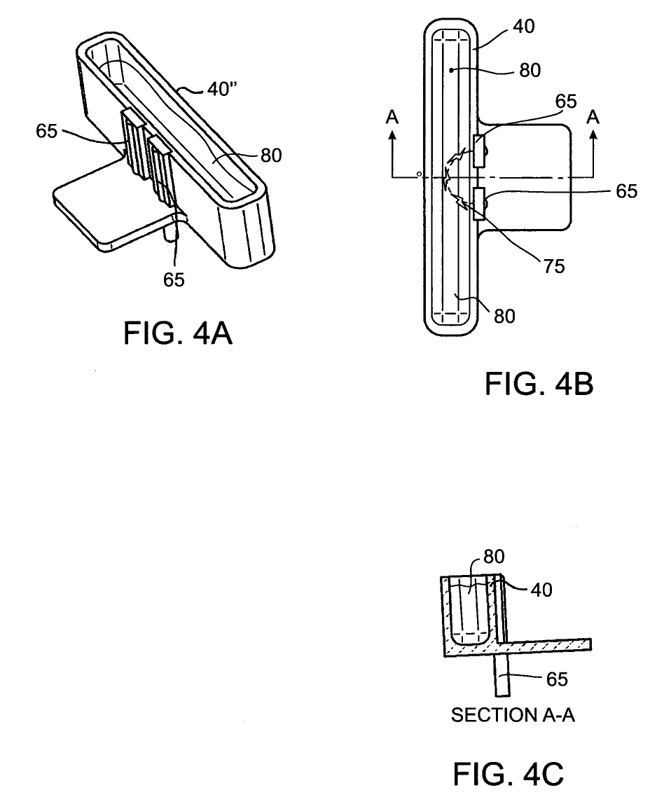

Reference is now made to FIGS. 4A, 4B and 4C showing an isometric, top, and cross sectional view of a sampling cell and external electrodes in accordance with some embodiments of the present invention. According to some embodiments of the present invention, external electrodes 65 are positioned outside sampling cell 40″ and/or are positioned so that the electrodes 65 are not in physical contact with milk sample 80. Optionally, electrodes 65 are flat electrodes. Typically, electrodes 65 are positioned close to milk sample 80, e.g. butting against a wall of the sampling cell. Optionally, the wall thickness of the sampling cell near electrodes 60 is thin, e.g. 0.7 mm. In response to an AC signal transmitted to one of electrodes 65, an AC current 75 flows between electrodes 65.

The present inventors have found that although the effect of the excitation signal on the milk sample is reduced when the electrodes are isolated from the milk sample, there are some advantageous to isolating the electrodes from the milk sample. For example, reduction in measurement accuracy due to milk constituents accumulating on the electrodes over time may be avoided. Isolation of electrodes 65 may also be effective in reducing maintenance required on the system, e.g. reducing required cleaning of electrodes and repeated calibration of the system. Additionally, a range of materials from which the electrodes can be constructed may be increased to include materials that may corrode and/or material that are not biocompatible. Optionally, the increased range of material may include material that is cheaper to manufacture and/or material that is more effective in transmitting a received signal. Optionally, sampling cell 40″ is oblong in shape. Alternatively, electrodes 65 are positioned on opposite walls of sampling cell 40″.

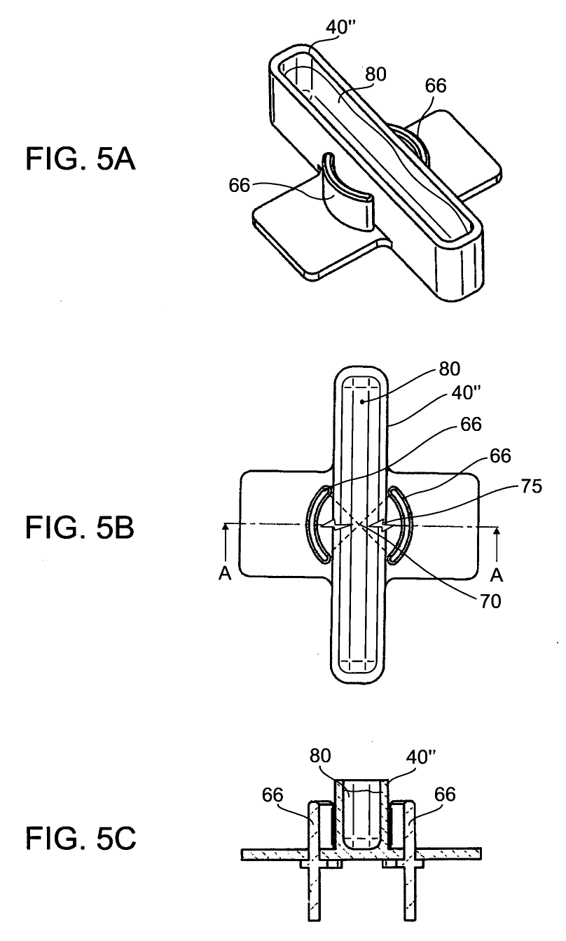

Reference is now made to FIGS. 5A, 5B and 5C showing an isometric, top, and cross sectional view of a sampling cell with external arc shaped electrodes in accordance with some embodiments of the present invention. According to some embodiments of the present invention, arc shaped electrodes 66 are positioned outside sampling cell 40″ and/or are positioned so that the arc shaped electrodes are not in physical contact with milk sample 80. Arc shaped electrodes 66 isolated from milk sample have similar advantages to those described in reference to electrodes 65 in FIGS. 4A, 4B, and 4C. Optionally, sampling cell 40″ includes a curved wall matching a curvature of electrodes 66 around which electrodes 66 are positioned so that a gap between electrodes 66 and milk sample 80 is minimal.

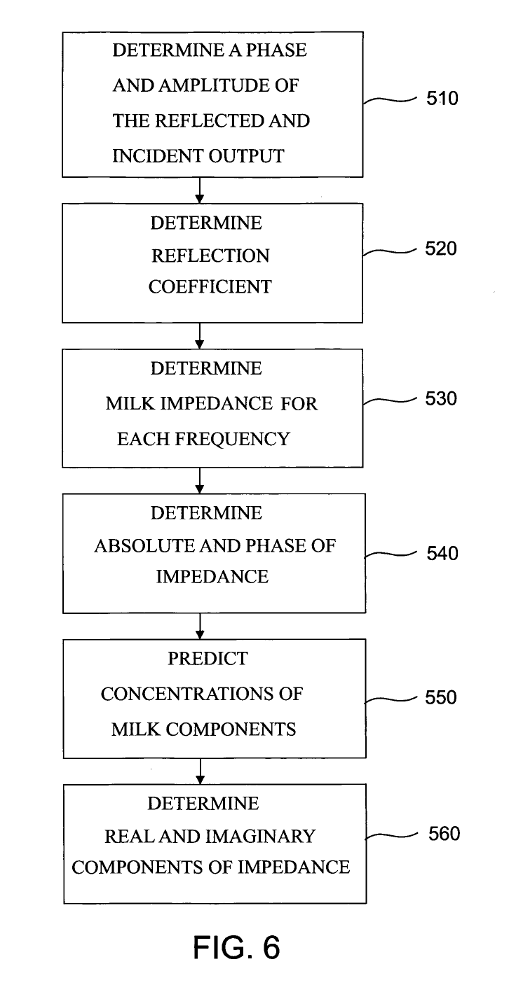

Typically, when isolating the electrodes from milk sample 80, the impedance of the system is increased so that it may be more difficult to detect relatively small changes in impedance due to milk excitation. According to some embodiments of the present invention, repeated sampling of milk sample 80 and filtering methods are used to improve impedance detection when using electrodes that are isolated from milk sample 80 such as described in FIGS. 5-6.

It is noted that although FIGS. 2-5 have been described in reference to a static sampling cell, similar arrangements of electrodes may also be applied to a flow through sampling cell, e.g. flow through sampling cell 40′ including replaceable milk sample 80′ as described in reference to FIG. 1B.

Reference is now made to FIG. 6 showing a simplified flow chart describing an exemplary method for determining impedance of milk in a sampling cell based on received incident and reflected signals in accordance with some embodiments of the present invention. According to some embodiments of the present invention, a phase and amplitude of the reflected and incident output is determined (block 510). According to some embodiments of the present invention, a reflection coefficient of the reflected over the incident signal is determined (block 520) by the following equation:

Γ=(|B|/|A|)*e^{j(ωt(θ}^{_{b}}^{-θ}^{ₐ}⁾⁾ (Equation 1)

where Γ is the reflection coefficient; |B|/|A| is the absolute amplitude of the reflected signal (B) divided by the absolute amplitude of the incident signal (A); θ_{b}−θₐ is the phase of the reflected signal (b) minus the phase of the incident signal (b); ω is the frequency of the incident signal; t is time; and j is \sqrt{−1}. In some exemplary embodiments, the reflection coefficient is determined by micro-controller 122. Optionally, reflection coefficient is determined by a processing unit associated with micro-controller 122. In some exemplary embodiments, amplitude and phase values for the incident and reflected signals are sampled by an Analog to Digital (A/D) converter and reflection coefficient is determined by digital processing.

According to some embodiments of the present invention, impedance of the milk for each frequency is determined based on the reflection coefficient and pre-determined impedance Zₒ of coaxial cable 110 (block 530) using the following relationship:

Zₘᵢₗₖ=Zₒ*(1+Γ)/(1−Γ) (Equation 2)

Optionally, Zₒ=50 Ohms is used as the reference impedance of the analysis system 100. Typically, an adjustment to correct for phase differences due to cable length is included although not described herein since such corrections are standard and well known to a person skilled in the art.

According to some embodiments of the present invention, impedance values are determined for each frequency in the generated sweep. According to some embodiments of the present invention, absolute impedance, |Zₘᵢₗₖ|, and an impedance angle (or phase), θₘᵢₗₖ, is determined for each frequency of the sweep (block 540).

According to some embodiments of the present invention, a real part, Rᵣₑₐₗ, and imaginary part X_{imaginary} of the impedance is determined (block 550) for each frequency in the sweep based on the following equations:

Rᵣₑₐₗ=|Zₘᵢₗₖ|*cos(θₘᵢₗₖ) (Equation 3)

and

X_{imaginary}=|Zₘᵢₗₖ|*sin(θₘᵢₗₖ) (Equation 4)

According to some embodiments of the present invention, real and imaginary parts of the impedance determined over one or more frequencies are entered into pre-defined polynomial expression relating one or more determined impedance values to concentration of pre-defined component in milk (block 560). Typically, a plurality of polynomial expressions are defined, one for each pre-defined component of milk. Optionally, a temperature of the milk is monitored and entered as a variable to the pre-defined polynomial. A description of the polynomial equations is described in further detail below.

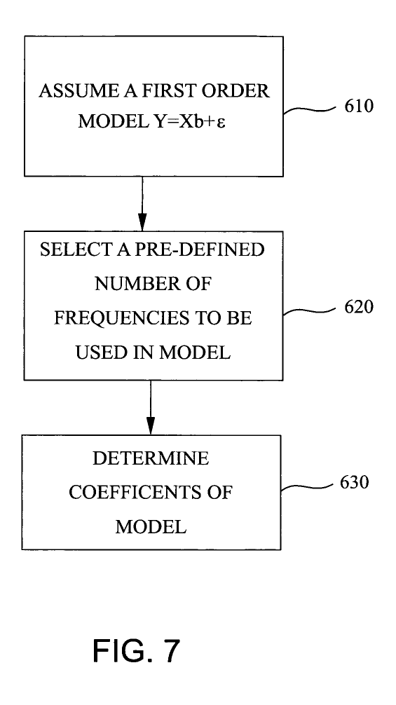

Reference is now made to FIG. 7 showing a simplified flow chart of an exemplary method for defining variable values for a polynomial expression to express a concentration of a pre-defined milk component as a function of determined impedance in accordance with some embodiments of the present invention. According to some embodiments of the present invention, a first order model is used to estimate concentration of pre-defined components of milk as a function of impedance values (block 610).

According to some embodiments of the present invention, a first order model may be expressed in the form of:

y=Xb+∈ (Equation 5)

where y is the vector of observations, X is a matrix of the variables, e.g. real and imaginary impedance values determined at a plurality of frequencies, b is the vector of regression coefficients, and c is the residuals. In some exemplary embodiments, impedance values obtained from about 100-200 frequencies, e.g. 128 frequencies are included the X matrix. Typically, the frequencies are discrete frequencies steps over a pre-defined range of frequencies, e.g. 0.3 MHz to 1.4 GHz.

According to some embodiments of the present invention, a Partial Least Square (PLS) regression method is used to determine coefficients of the first order model. Typically, the model is developed from a set of N observations, e.g. measured concentration values of a milk component with k independent variables. Typically, the independent variables are amplitude and phase of impedance or real and imaginary components of the impedance. Optionally, when the temperature is not regulated, temperature is also used as one of the variables of the first order model. Optionally, temperature coefficients are a function of temperature. Typically, the measured concentrations of selected milk components are independently determined using known spectrophotometric methods. The know concentrations of the selected components are then used to extract the empirical coefficients by using for example, PLS.

Typically, when performing analysis of continuous spectral data the observation matrix must be reduced not only for practical reasons, e.g. to reduce the number of terms of the expression but also for performance reasons. Continuous data often introduces co-linearity to the model which translates into “noise”. This may be particularly relevant to impedance values measured at neighboring sweep frequencies. Two vectors (frequencies) carrying the same or similar information which are used within the same model will increase the error. Ideally, a reduced matrix (one that would hold most information and no “noise”) where all vectors are orthogonal and the correlations between each two vectors is zero is desirable.

In some exemplary embodiments, the vectors to be used in the model are determined by cross validation. Typically, in cross-validation only a part of the full data set is used for the calibration. Data not included in the calibration is then used to test the predictive ability of the model. In the leave-one-out cross-validation model the model is calibrated on all data but one. That data point is used for estimation. The procedure is repeated until all observations have been left out once. Average errors are computed to evaluate the model. Optionally, the error used is the root mean square error of the cross validation. The number of frequencies corresponding to the lowest error defines the optimum number of variable to use. Optionally, a best performance is acquired by performing iterations of correlation calculations between all vectors leaving in only vectors which the correlation between them is less 0.3.

According to some embodiments of the present invention, a predefined number of frequencies to be used in the model are selected, e.g. more than 3 frequencies, 8-15 frequencies, 8-10 frequencies, or 10-12 frequencies ranging between 0.3 MHz and 1.4 GHz (block 620), representing frequencies having relatively low correlations between them.

According to some embodiments of the present invention, iterative PLS is used to determine the number of variables to be used in the model. Optionally, a selection criterion is that the average of the root mean square errors of the calibration and estimation must be lower then the lowest value for the frequency to be included or excluded.

Optionally, a first iteration includes all frequencies in the matrix and during each of the iterations, one vector that provides the best result is excluded. As the iteration process proceeds, the best k vectors are selected. Alternatively, an initial matrix includes only one vector and an additional vector is added during each of the iterations until turnover is reached. In some exemplary embodiments, optimization is performed based on lowest root mean square error of cross validation) or the highest correlation of R squared.

According to some embodiments of the present invention, coefficients of the polynomial expression corresponding to selected frequencies for each of the pre-defined components are determined and saved in memory. Optionally, the determined coefficients are stored along with the concentrations of samples with which they are associated as a reference database for use in measurements of unknown samples. In some exemplary embodiments, predication of the concentrations of pre-defined milk components from unknown milk samples are performed by further statistical analysis method that compare measured impedances with contents of the database. Comparable methods are known from chemometric analysis which is used in the analysis of multiple component chemical reaction dynamics.

### Experimental Study

Milk samples were collected from 120 Holstein cows. Dielectric spectrum of each sample was acquired using HP 8711A RF network analyzer generating signal from 300 KHz to 1.3 GHz. Lower frequencies spectra (30 KHz to 100 KHz) were acquired for each sample using an AD5933 impedance analysis system. Higher frequencies (300 KHZ to 1.3 GHz) were performed with a commercial extreme-ultraviolet imaging spectrometer. The signal was applied to a pair of electrodes 5 mm apart installed in a measuring sample chamber. The electrodes were cylinder shaped with a diameter of 2.5 mm and protruded 3 mm from the floor of the sampling cell. The milk samples components concentrations were analysed with laboratory equipment (Combi MilkoScan™, Foss Analytical A/S, DK-3400, HiHerød, Denmark). The spectra were acquired at 7 different temperatures of the milk in the cell (15, 20, 25, 30, 35 40, and 45 degree Celsius).

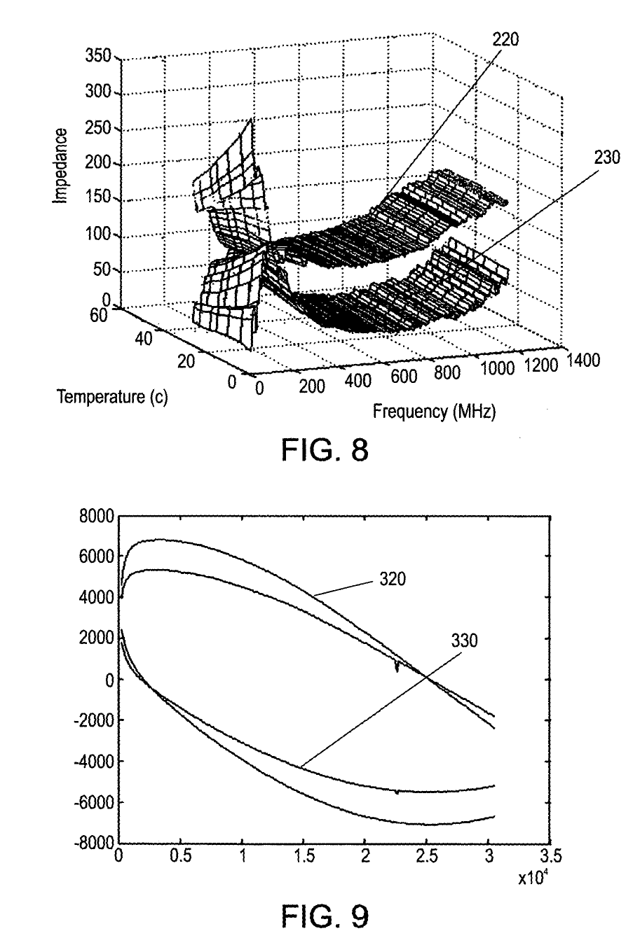

FIG. 8 shows an exemplary plot of real and imaginary RF spectrum of a milk sample over seven different temperatures. The present inventors have found that both the real component 220 and imaginary 230 component of impedance is most sensitive to changes in temperature at lower frequencies range (200-600 MHz) and also high frequency range (1 to 1.4 GHz).

FIG. 9 shows an exemplary Nyquist diagram of bacterial contaminated milk as compared to healthy milk in accordance with some embodiments of the present invention. As can be seen in FIG. 9 there is a qualitative difference between the Nyquist diagrams from contaminated and healthy milk. Healthy milk 320 was obtained from a milk sample representing a healthy cow with low SCC of about 100K. Contaminated milk 330 was obtained from bacterial infected milk containing high SCC of about 3 million. It can be clearly seen that high and low SCC can be distinguished using the system and methods described herein.

Principal Component Analysis (PCA) and PLS regression were performed on the spectra employing both amplitude and phase data. Calibration models was performed with PLS regression utilizing the spectra and their respective reference data to determine latent variables.

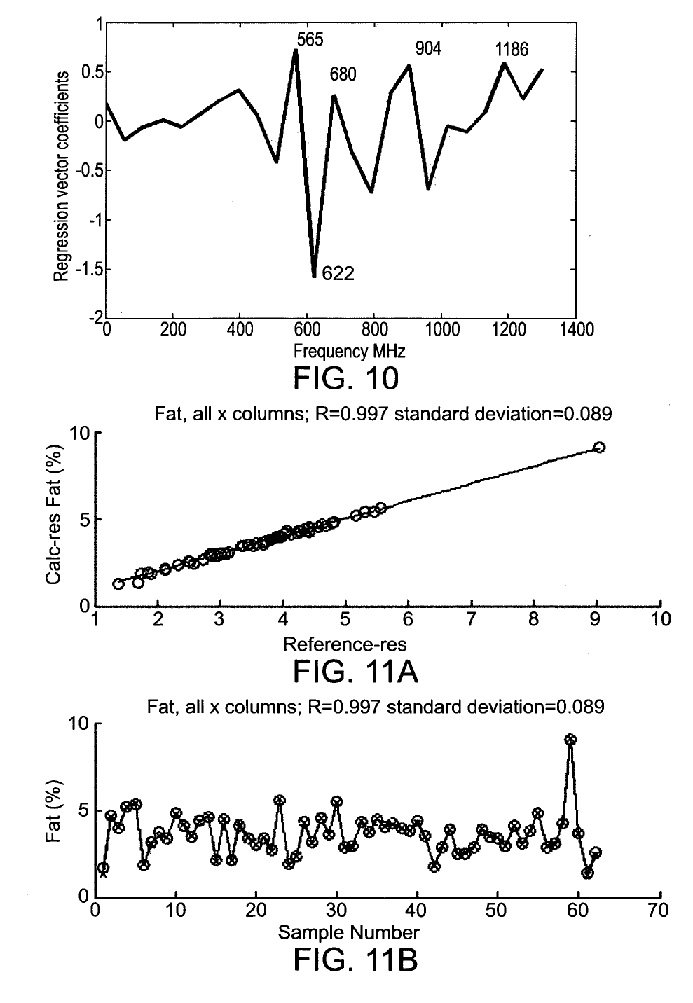

FIG. 10 shows a plot of experimentally found regression vector coefficients for milk lactose determination when using a particular experimental structure in accordance with some embodiments of the present invention. Similar plots were obtained from fat, protein, SCC and urea. The regression vector plots showed highest sensitivity at the following frequencies:

1. Fat: 185 MHz, 370 MHz

2. Protein: 930 MHz, 1115 MHz

3. Lactose: 622 MHz, 904 MHZ

4. SCC: 380 MHz, 790 MHz

5. Urea: 850 MHz, 1070 MHz

Cross validation was performed by separating the samples to a random model group and validation group (approximately half and half) and by performing leave one out cross validation

Results of a validation group consisting of 62 samples of a model developed using 58 samples for fat, protein, lactose, log(SCC) and urea are displayed in the following figures.

FIG. 11A shows a plot showing an exemplary correlation between measured and estimated values of fat based on experimental results with a particular structure in accordance with some embodiments of the present invention. The measured value is represented by the line and the estimated values are presented by the circles. The estimated values of fat shown were based on impedance measurements taken at 12 different frequencies.

FIG. 11B shows an exemplary plot showing exemplary measured and estimated values of fat in accordance with some embodiments of the present invention. The measured value is represented by the line with ‘x’ and the estimated values are presented by the circles.

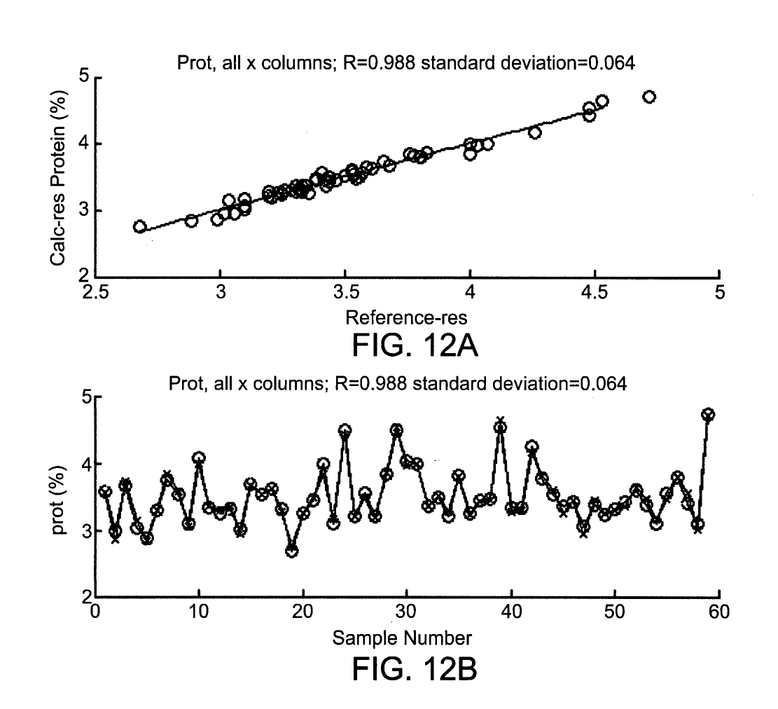

FIG. 12A shows an exemplary plot showing an exemplary correlation between measured and estimated values of protein in accordance with some embodiments of the present invention. The measured value is represented by the line and the estimated values are presented by the circles. The estimated values of protein shown were based on impedance measurements taken at 12 different frequencies.

FIG. 12B shows an exemplary plot showing exemplary measured and estimated values of protein in accordance with some embodiments of the present invention. The measured value is represented by the line with ‘x’ and the estimated values are presented by the circles.

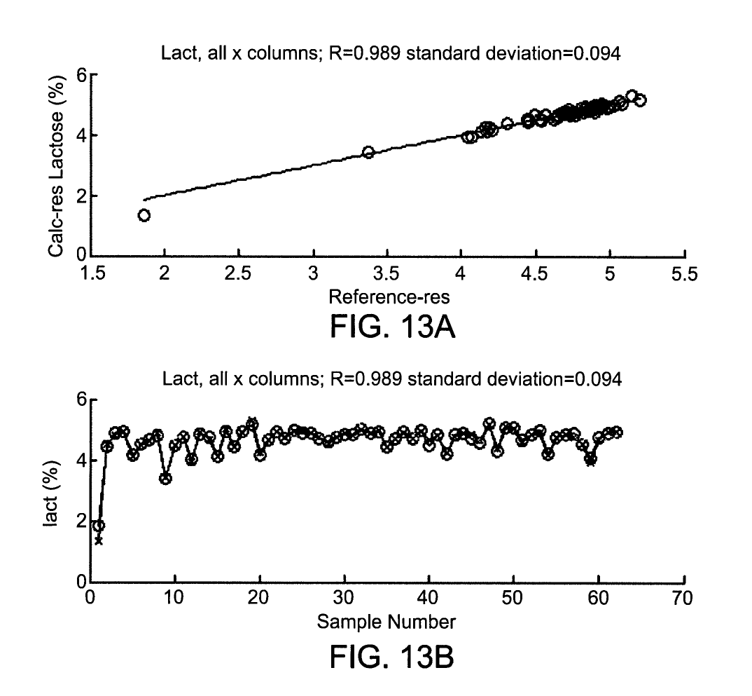

FIG. 13A shows is an exemplary plot showing an exemplary correlation between measured and estimated values of lactose in accordance with some embodiments of the present invention. The measured value is represented by the line and the estimated values are presented by the circles. The estimated values of lactose shown were based on impedance measurements taken at 12 different frequencies.

FIG. 13B is an exemplary plot showing exemplary measured and estimated values of lactose in accordance with some embodiments of the present invention. The measured value is represented by the line with ‘x’ and the estimated values are presented by the circles.

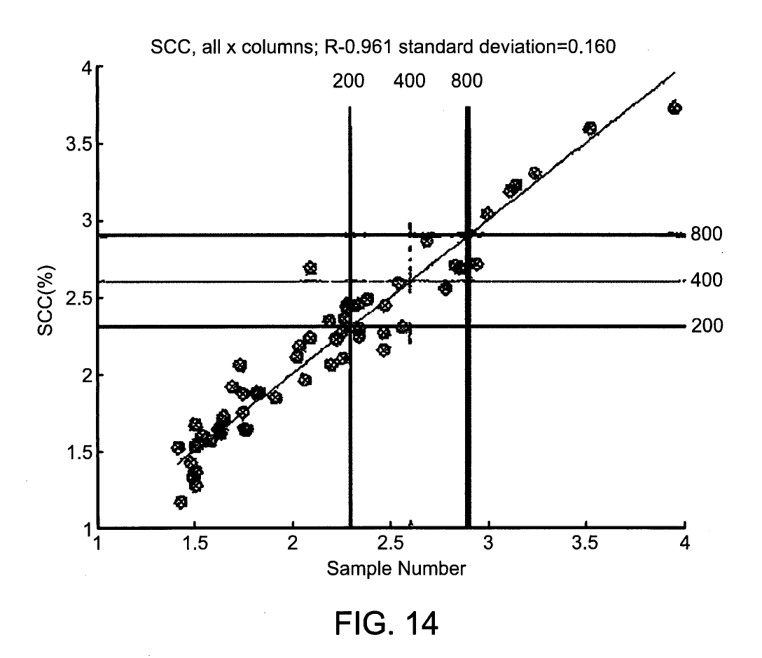

FIG. 14 shows an exemplary plot showing an exemplary correlation between exemplary-measured results and estimated values for log of SCC in accordance with some embodiments of the present invention. The estimated values for log of SCC shown were based on impedance measurements taken at 12 different frequencies.

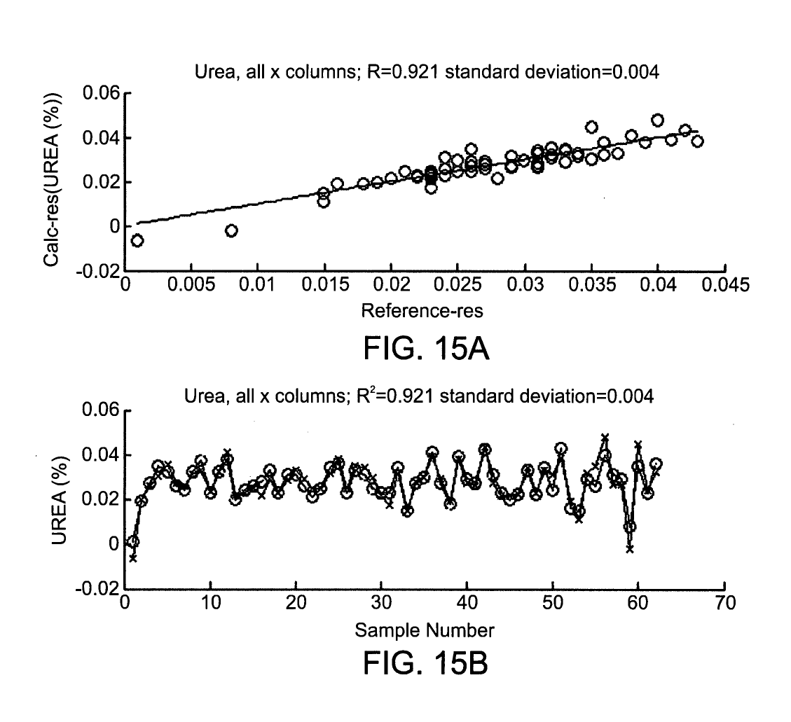

FIG. 15A shows is an exemplary plot showing an exemplary correlation between measured and estimated values of urea in accordance with some embodiments of the present invention. The measured value is represented by the line and the estimated values are presented by the circles. The estimated values of urea shown were based on impedance measurements taken at 12 different frequencies.

FIG. 15B shows an exemplary plot showing exemplary measured and estimated values of urea in accordance with some embodiments of the present invention. The measured value is represented by the line with ‘x’ and the estimated values are presented by the circles.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1. A method for determining a concentration of at least one component of milk, the method comprising:
measuring impedance values between two electrodes associated with a cell containing a milk sample at each of at least three frequencies; and
estimating a concentration of the at least one component from a polynomial expression in which the impedance values at the at least three frequencies are variables.

2. A method according to claim 1 wherein the components of the polynomial expression are defined based on analysis of impedance values and concentrations values of the at least one component of milk, wherein the concentrations values are determined by another means and wherein the at least one component of milk is obtained from a plurality of samples.

3. The method according to claim 1, wherein component of the polynomial expression is defined as a function of impedance measured at between 8 to 10 pre-selected frequencies.

4. The method according to claim 1, further comprising selecting the at least three frequencies for estimating concentrations of each milk component based on an iterative partial least square regression.

5. The method according to claim 4, wherein the selecting is based on an iterative partial least square regression.

6. The method according to claim 1, wherein the at least three frequencies range between 0.3 MHz to 1.4 GHz.

7. The method according to claim 1, wherein the at least three frequencies are a frequency sweep of discrete frequencies over a defined band.

8. The method according to claim 1, wherein the estimating is performed using chemometric analysis.

9. The method according to claim 1, wherein the estimating is performed on a milk sample contained in a flow through sampling cell, wherein the sampling cell repeatedly and automatically receives milk samples from a milk conduit as milk flows through the conduit.

10. The method according to claim 1, wherein the estimating is performed on-line in a milking parlor.

11. The method according to claim 1, wherein the milk sample is stationary in the sampling cell.

12. The method according to claim 1, wherein the polynomial expression includes temperature as a variable.

13. The method according to claim 1, wherein the polynomial expression is defined based on partial least square regression method or wherein the polynomial expression is a first order expression.

14. The method according to claim 1, wherein the polynomial expression is a first order expression.

15. A system for determining a concentration of at least one component of milk comprising:
a sampling cell including a milk sample;
electrodes operative to electrify the milk sample with excitation signals at a plurality of frequencies including at least three frequencies;
a signal generator for generating the excitation signals;
circuitry for determining a relationship between an amplitude and phase of reflected and incident signals obtained from the signal generator; and
a processor that receives the relative amplitude and phase and estimates a concentration of at least one component of milk based on a polynomial expression relating measured impedance values at a plurality of frequencies to concentrations of at least one component of milk.

16. The system according to claim 15, wherein the signal generator generates signals at frequencies ranging between 0.3 MHz and 1.4 GHz.

17. The system according to claim 15, further comprising a memory for storing pre-defined empirical coefficients of the polynomial expression along with the concentrations of the components of milk with which they are associated as a reference database for use in measurements of unknown samples.

18. The system according to claim 15, wherein the sampling cell is a flow through sampling cell that repeatedly and automatically receives milk samples from a milk conduit as milk flows through the conduit.

19. The system according to claim 18, wherein the sampling cell is a recessed cavity adjoining a main flow conduit of milk in a milk-parlor.

20. The system according to claim 15, wherein the circuitry includes a directional coupler that receives a signal reflected from the milk sample in response to excitation of the milk sample.

21. The system according to claim 15, further comprising a controller operative to store the amplitude and phase values in response to detecting a steady input from the circuitry.

22. The system according to claim 21, wherein the controller is further operative to synchronize electrifying of the milk sample with reception of the milk sample.

23. The system according to claim 15, wherein the electrodes are coated with lipophobic material.

24. The system according to claim 15, wherein the electrodes are concentric.

25. The system according to claim 24, wherein the electrodes include a ring shaped electrode surrounding an inner electrode.

26. The system according to claim 25, wherein the ring shaped electrode includes one or more openings through which a milk sample can flow.

27. The system according to claim 15, wherein the electrodes are arc shaped electrodes.

28. The system according to claim 27, wherein the electrodes are positioned with respect to each other so that their circle-centers coincide.

29. The system according to claim 15, wherein the electrodes are physically isolated from the milk sample.
